(19) United States
(12) Patent Application Publication
(10) Pub. No.: US 2024/0072499 A1
(43) Pub. Date: Feb. 29, 2024

(54) Single Pair Ethernet Jack with Rear Facing Termination

(71) Applicant: Panduit Corp., Tinley Park, IL (US)

(72) Inventors: Jason O'Young, Tinley Park, IL (US); Robert E. Fransen, Orland Park, IL (US); Satish I. Patel, Roselle, IL (US); Robert L. Fritz, Elwood, IL (US)

(73) Assignee: Panduit Corp., Tinley Park, IL (US)

(21) Appl. No.: 17/899,828

(22) Filed: Aug. 31, 2022

(51) Int. Cl. H01R 24/22; H01R 24/64

(52) U.S. Cl. CPC H01R 24/22; H01R 24/64; H01R 2201/04

(57) ABSTRACT

A communications connector has a jack housing and a pair of plug interface contacts. The plug interface contacts each have an insulation displacement contact end and a plug interface end. The plug interface end and the insulation displacement contact end each have a broad face and, the broad face of the plug interface end and the insulation displacement contact of each plug interface end contact are parallel to each other. Additionally, the broad faces of each contact also being parallel to each other.

### FIELD OF THE INVENTION

The present invention is related generally to electrical connectors and more specifically to a single pair ethernet jack.

### BACKGROUND

Some current single pair ethernet (SPE) plugs currently provide a small form factor design that is simple and inexpensive to manufacture, as well as quickly and easily terminated and unterminated by an installer without complex and expensive tools. What is needed is a shielded single pair ethernet jack solution that mates with current and future single pair ethernet plugs.

### SUMMARY

A communications connector has a jack housing and a pair of plug interface contacts. The plug interface contacts each have an insulation displacement contact end and a plug interface end. The plug interface end and the insulation displacement contact end each have a broad face and, the broad face of the plug interface end and the insulation displacement contact of each plug interface end contact are parallel to each other. Additionally, the broad faces of each contact also being parallel to each other.

### BRIEF DESCRIPTION OF THE FIGURES

FIG. 1 is an isometric view of a communications system using an SPE jack according to the present invention.

FIG. 2 is an isometric view of the SPE jack in FIG. 1.

FIG. 3 is an exploded isometric view of the SPE jack of FIG. 2.

FIG. 4 is an isometric view of the plug interface jack contacts of the SPE jack of FIG. 2.

FIG. 5 is a rear isometric view of the shielded jack housing of the SPE jack of FIG. 2.

FIG. 6 is an exploded isometric view of the termination cap of the SPE jack of FIG. 2.

FIG. 7 is a rotated exploded isometric view of the termination cable of the SPE jack of FIG. 2.

FIG. 8 is a partially exploded view of the jack of FIG. 2 with a Mini-Com adapter.

FIG. 9 shows an isometric view of the jack of Fig. placed in a Mini-Com adapter and then placed in a panel.

### DESCRIPTION OF THE INVENTION

The present invention is a shielded single pair ethernet (SPE) jack with a ratcheting cable strain relief.

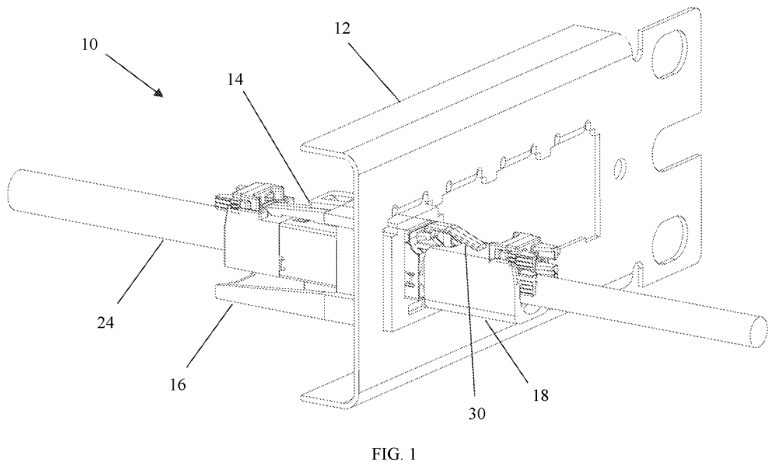

FIG. 1 is an isometric view of communications system 10 which includes panel 12, single pair ethernet jack assembly 14, Mini-Com adapter 16, and single pair ethernet plug assembly 18.

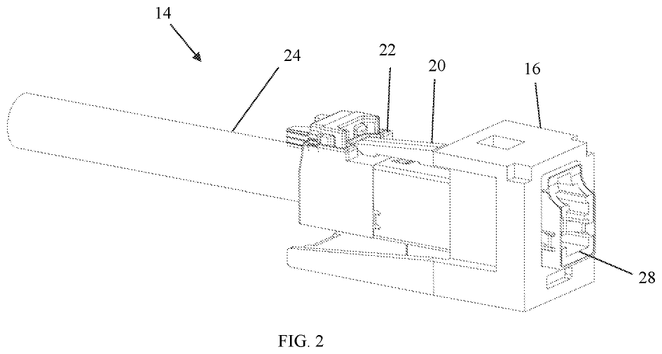

FIG. 2 is an isometric view of jack assembly 14 which includes shielded jack housing 20, termination cap 22, and single pair ethernet cable 24. Plug assembly 18 mates to jack assembly 14 through plug opening 28 and is retained using plug latch 30.

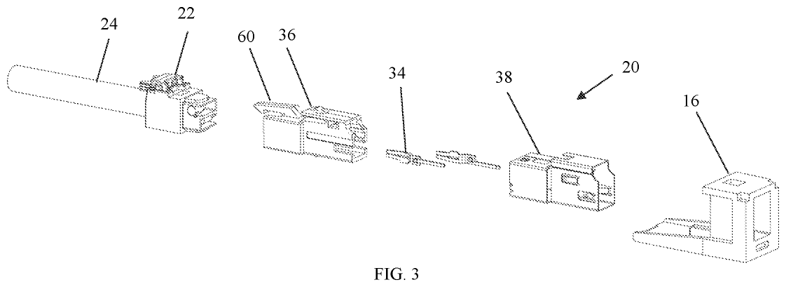

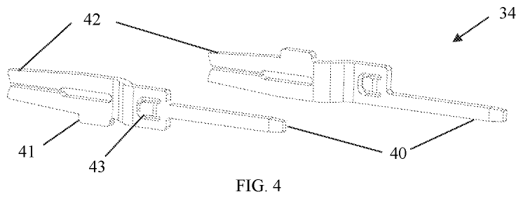

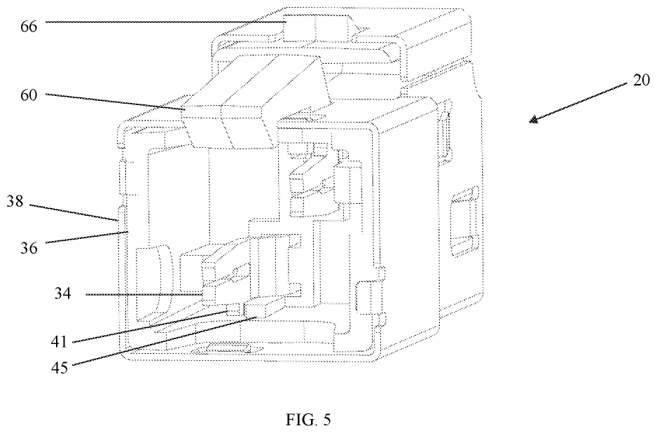

FIG. 3 is an exploded isometric view of shielded jack housing 20 which includes jack body 36, jack contacts 34, and shield 38. Jack contacts 34 (FIG. 4) have a plug interface contact (PIC) end 40 and an insulation displacing contact (IDC) end 42. FIG. 5 is a rear isometric view of shielded jack housing 20. Contact stabilizing tab 41 and stabilizing rib 45 helps maintain the position of jack contact 34 during termination. Contact retention tab 43 secures jack contact 34 in jack body 36.

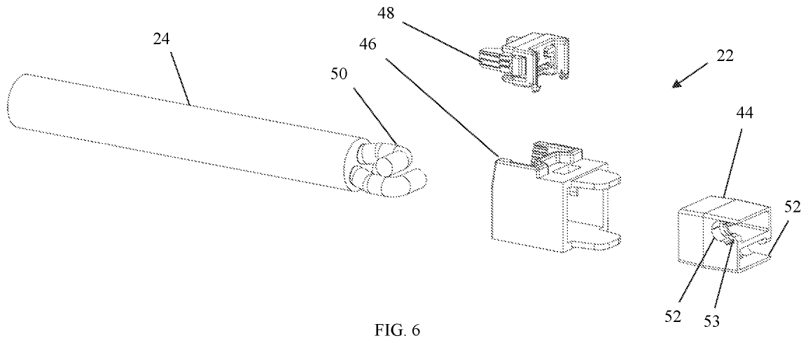

FIG. 6 is an exploded isometric view of termination cap 22 which includes wire cap 44, die cast rear cover 46, and ratcheting strain relief clip 48. IDC end 42 of jack contact 34 will touch conductors 50 of ethernet cable 24 when termination cap 22 is mated to shielded jack housing 20.

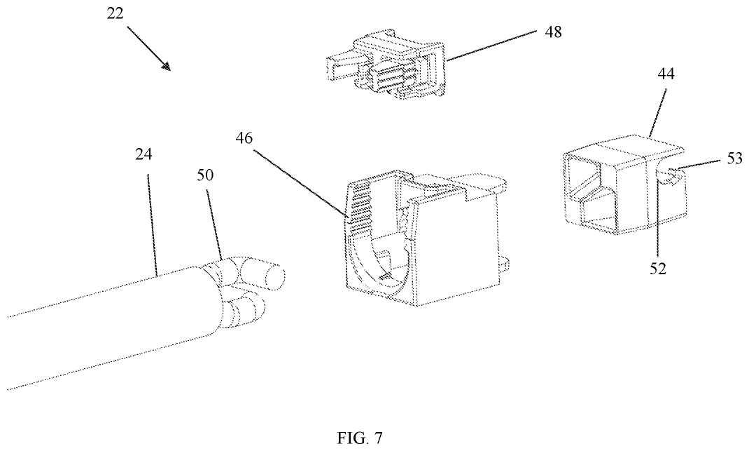

FIG. 7 is a rotated exploded view of termination cap 22 and ethernet cable 24. Conductors 50 of ethernet cable 24 are fed through the rear of termination cap 22 and routed through wire cap 44. Each conductor 50 is placed into a separate conductor holder slot 52 and held in place with retention tab 53. Termination cap 22 is secured to shielded jack housing 20 with latch 60.

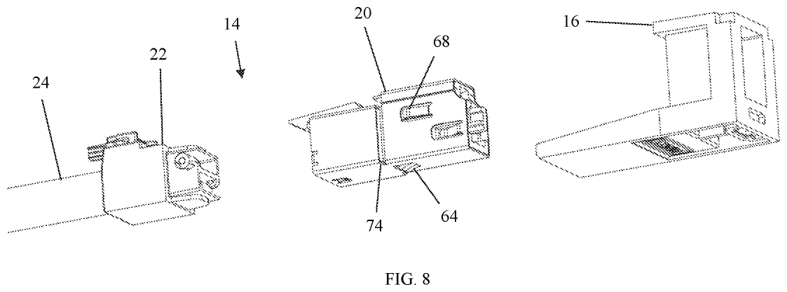

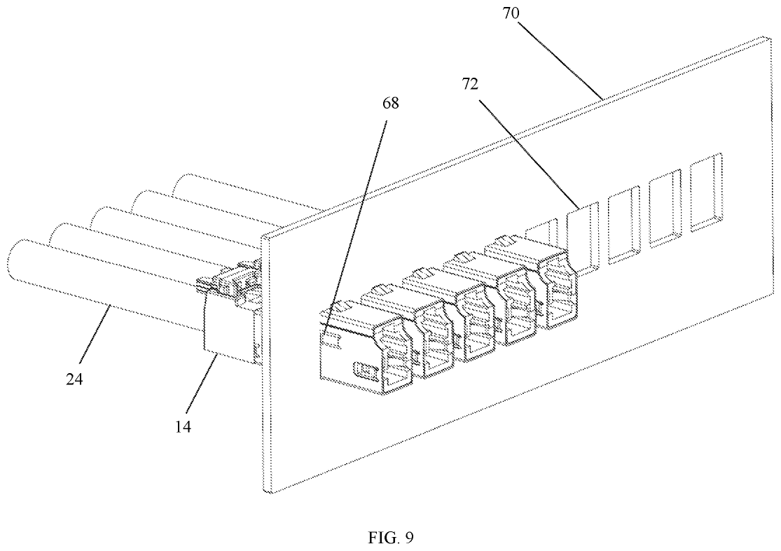

Jack assembly 14 is joined to Mini-Com adapter 16 utilizing stationary snap 64 and moveable snap 66 on shielded jack housing 20 (FIG. 8). Jack grounding tabs 68 create a bond with Mini-Com adapter 16 which in turn is bonded to panel 12. Alternatively, jack assembly 14 can be installed directly into panel 70 with rectangular apertures 72 (FIG. 9). Moveable snap 66, stationary snap 64, and mid wall 74 secure jack assembly 14 within rectangular aperture 72. Rectangular aperture 72 is not limited to panel 70 and could be part of a surface mount box, faceplate, rack mount patch panel, DIN rail panel, or any similar device used to hold structured cabling products.

While particular embodiments and applications of the present invention have been illustrated and described, it is to be understood that the invention is not limited to the precise construction and compositions disclosed herein and that various modifications, changes, and variations may be apparent from the foregoing without departing from the spirit and scope of the invention as described.

1. A communications connector comprising:
a jack housing; and
a pair of plug interface contacts wherein the plug interface contacts each have a insulation displacement contact end and a plug interface end, the plug interface end and the insulation displacement contact end each having a broad face, the broad face of the plug interface end and the insulation displacement contact of each plug interface end contact being parallel to each other, and the broad faces of each contact also being parallel to each other.

2. A communications connector comprising:
a jack housing; and
a pair pf plug interface contacts wherein each plug interface contact has at least one bend and further wherein the at least one bend of each plug interface contact is aligned such that the pair of plug interface contacts bend away from a vertical center plane uniformly to maintain electrical separation.

3. A communications connector comprising:
a jack housing; and
a pair of plug interface contacts, each plug interface contact of the pair of plug interface contacts having a pair of insulation displacement tines wherein at least one tine of the pair of tines has a protruding stabilizing tab configured to engage the jack housing in order to constrain extraneous movement during termination.
